(19) United States
(12) Patent Application Publication
(10) Pub. No.: US 2013/0100127 A1
(43) Pub. Date: Apr. 25, 2013

(54) METHOD FOR GEOGRAPHICALLY DISPLAYING OIL AND GAS RELATED INFORMATION

(71) Applicants: Erik Paul Gilje, Brooklyn, NY (US); Evan Christoffer Anderson, Nichols Hills, OK (US)

(72) Inventors: Erik Paul Gilje, Brooklyn, NY (US); Evan Christoffer Anderson, Nichols Hills, OK (US)

(21) Appl. No.: 13/660,556

(22) Filed: Oct. 25, 2012

Related U.S. Application Data
(63) Continuation of application No. 12/504,134, filed on Jul. 16, 2009.

(51) Int. Cl. G09G 5/377; G06T 15/00

(52) U.S. Cl. CPC G09G 5/377; G06T 15/00
USPC 345/419; 345/634

(57) ABSTRACT

A method and system for generating output files which represent computer displayable geographically related data related to the oil and gas industries. The method and system provides an approach for representing vast amounts of data related to oil and gas industry assets geographically so that the data may be displayed in two and three-dimensions. The method and system provide a way of inputting raw data and outputting a file that may be processed by a geographic information system software package to visually represent the data geographically on the surface of the earth The output file may also be in a number of other file formats and readable by other software applications.

### CROSS REFERENCE TO RELATED APPLICATION

This application is a continuation of U.S. patent application Ser. No. 12/504,134 entitled METHOD FOR GEOGRAPHICALLY DISPLAYING OIL AND GAS RELATED INFORMATION, filed Jul. 16, 2009, which claims priority to U.S. Provisional Patent Application No. 61/081,562 filed Jul. 17, 2008.

### BACKGROUND OF THE INVENTION

The embodiments discussed therein are directed to a system for geographically indicating information related to the oil and gas industries and, more particularly, to a system accepting input raw data related to the oil and gas industries, and providing an output file used to display the information related to the oil and gas industries geographically by inputting the output file into a Geographic Information System.

### DESCRIPTION OF THE RELATED ART

There has recently been growth of a number of commercially available geographic information systems, for example, Google Earth, Microsoft Virtual Earth, and ArcGIS which allow a user to visually fly around and view satellite images of the entire earth in either two-dimensional and three-dimensional views using a computer. A user can click and drag an input device, such as a mouse, to move about the earth and view the terrain of the earth. The user may zoom in and out to view the earth from as far away as outer space or as close as only viewing a canyon, river, building in a city, or a field. These geographic information systems allow a user to input a file and display an overlay from the data of the file on top of the displayed terrain of the earth. Google Earth, as an example, allows a user to input a geospatial data file which is in the format of Keyhole Markup Language (KML). This input file provides a user with the ability to overlay images and data onto the earth and display this data.

Both the oil and gas industries require recordation of a vast amount of data which is difficult to geographically represent and document easily. Currently companies try to meet their analytical needs with a wide range of limited options. Some companies rudimentarily just draw a map by hand or use push pins to represent data. Other companies manually create output files that are readable by software geographic information system packages. For example, a company may draw out with the aid of a computer mouse, where they have taken a lease. The hand drawn data requires a lot of manual interaction, and is not readily updatable in a systematic process.

One of the goals of the embodiments is to utilize a computer to generate Keyhole Markup Language output files for oil and gas data which can be input into a geographic information system (GIS) software package, such as Google Earth, to overlay data from the output file onto satellite images of the earth to provide geographically related data for oil and gas industry assets.

What is needed is a system that automates the process of creating these output files and displaying oil and gas industry related information for easy viewing on a display using a GIS software package.

### SUMMARY OF THE INVENTION

It is an aspect of the embodiments to provide an interface that easily allows creation of output files which are aggregations of large amounts of data related to oil and gas industry assets.

It is another aspect of the embodiments to allow for displaying an output file as output data using a geographic information system.

It is yet another aspect of the embodiments to allow the data of multiple output files to be overlaid on satellite images of the earth or a geographic representation of the earth on a display using a geographic information system.

It is yet another aspect of the embodiments to allow a user to create output filed based on several different data sources tailored to particular needs.

The application provides a method, system, and interface for generating output files which represent computer displayable geographically related data related to the oil and gas industries. The method and system allow vast amounts of data related to the oil and gas industry assets to be represented geographically so that the data may be displayed in two and three-dimensions. The method and system provide a way of inputting raw data and outputting a file that may be processed by a geographic information system software package such as Google Earth to visually represent the data geographically on the earth. The output file may also be in a number of other file formats and readable by other software applications.

These together with other aspects and advantages which will be subsequently apparent, reside in the details of construction and operation as more fully hereinafter described and claimed, reference being had to the accompanying drawings forming a part hereof, wherein like numbers refer to like parts throughout.

### BRIEF DESCRIPTION OF THE DRAWINGS

FIG. 1 depicts a geographic information system displaying satellite images of the earth with data overlaid from multiple data files.

FIG. 2 depicts a computer as hardware of the embodiments.

FIG. 3 shows a user interface.

FIG. 4 shows an overall process to create output files.

FIG. 5 shows a data structure for an “Area of Interest Data” and FIG. 5A shows a data structure for a “Master Land Description.”

FIG. 6 shows how an output file for Drilling Activity is created according to an embodiment.

FIG. 7 shows an example of a header that is written to an output file.

FIG. 8 shows a data structure for “Drilling Data.”

FIG. 9 depicts an example of how a Drilling Activity output file is viewed in a geographical information system.

FIG. 10 shows how an output file for Drilling Completions is created according to an embodiment.

FIG. 11 depicts an example of how a Drilling Completions output file is viewed in a geographical information system.

FIG. 12 shows how an output file for Open Acreage is created according to an embodiment.

FIG. 13 depicts an example of how an Open Acreage output file is viewed in a geographical information system.

FIG. 14 shows a data structure for “Pooling Data.”

FIG. 15 shows a data structure for “Production Data.”

FIG. 16 shows a data structure for “Master Leasing Data.”

FIG. 17 shows how an output file for Well Info output file is created according to an embodiment.

FIG. 18 depicts an example of how a Well Info output file is viewed in a geographical information system.

FIG. 19 shows how an output file for Vertical Well Production Bar is created according to the embodiment.

FIG. 20 depicts an example of how a Vertical Wall Production Bar output file is viewed in a geographical information system.

FIG. 21 shows how an output file for Land Activity is created according to an embodiment.

FIG. 22 depicts an example of how a Land Activity output file is viewed in a geographical information system.

FIG. 23 shows how an output file for Vertical Section Production Bar is created according to an embodiment.

FIG. 24 depicts an example of how a Vertical Section Production Bar output file is viewed in a geographical information system.

FIG. 25 shows how an output file for Land Boundaries is created according to an embodiment.

FIG. 26 depicts an example of how a Land Boundaries output file is viewed in a geographical information system.

FIG. 27 shows how an output file for Section Information is created according to an embodiment

FIG. 28 depicts an example of how a Section Information output file is viewed in a geographical information system.

FIG. 29 shows a data structure for “Spacing Data.”

FIG. 30 shows how an output file for Not Held by Production is created according to an embodiment

FIG. 31 depicts an example of how a Not Held by Production output file is viewed in a geographical information system

FIG. 32 shows a data structure for “Non Held by Production Data.”

FIG. 33 shows a data structure for “Plugging Data.”

FIG. 34 shows how an output file for Leasing Activity is created according to an embodiment.

FIG. 35 depicts an example of how a Leasing Activity output file is viewed in a geographical information system.

### DETAILED DESCRIPTION OF THE PREFERRED EMBODIMENTS

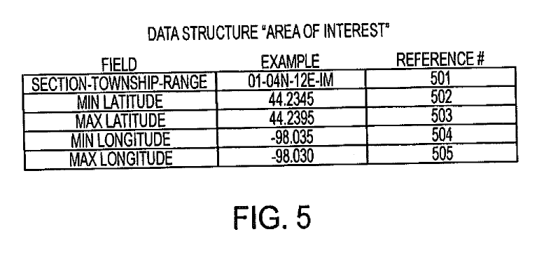

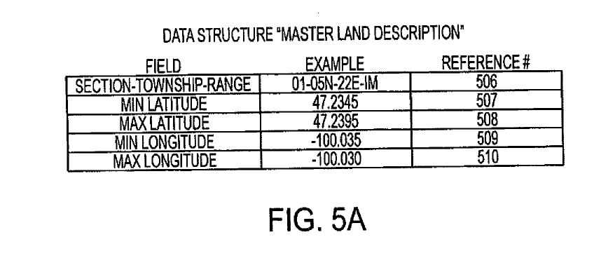

The embodiments related generally to the oil and gas industry, and in particular, to a method of processing and generating synthesized output from raw data by a computer. The raw data may be in the form of a number of data structures related to the oil and gas industry and contain a plurality of data related to oil and gas assets. Each data structure provides oil and gas associated data fields which may be stored on a computer readable medium. For instance, the data structures provide raw data related to area of interest, master land description, drilling data, pooling data, production data, master leasing data, spacing data, not held by production data, and plugging data as shown in FIGS. 5, 5A, 8, 14, 15, 16, 29, 32, and 33. Output files created by processing the raw data are formatted, such that they can be read by a commercially available geographic information system (GIS) application, which provides the viewer with a visual multi-dimensional view of the information. Additionally, the underlying data can also be readily outputted to be readable by Microsoft Excel, as comma separated values (csv), or as a simple text file. The method can be applied to the following types of data which relate to the oil and gas industry: production, drilling, land, and leasing data. Leasing data may include, as an example, legal and governmental filings such as deeds of record, tax filings, etc.

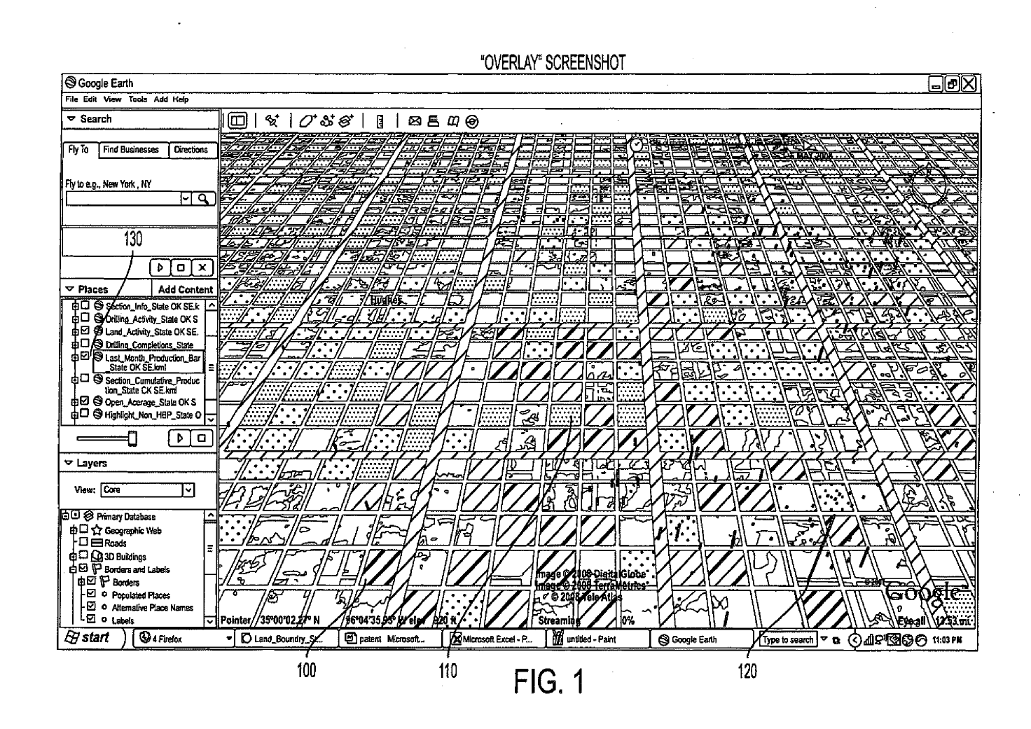

The embodiments describe a method for converting data from various oil and gas data sources into output files which are easily viewed in commercially available GIS applications. Output files can be visualized and read by commercially available GIS applications. A key aspect of the method is that it generates distinct output files for various types of data which the user may be interested in, enabling a user to overlay various pieces of information in a GIS viewer to gain a broader understanding of what is going on in a particular “Area of Interest” with regards to oil and gas activity. An example of the output can be seen in FIG. 1 which shows a geographic display region. This geographic display region provides a view of a geographical area and has an overlay of data on the view related to oil and gas assets which are in the area. As an example, the overlay of data can be seen at reference numeral 100 (Land Activity), 110 (Open Acreage), and 120 (Vertical Well Production Bars). As shown in this embodiment, overlays can be toggled on and off by selecting the checked boxes, as indicated by 130. The following provides a detailed explanation as to how these output files are generated.

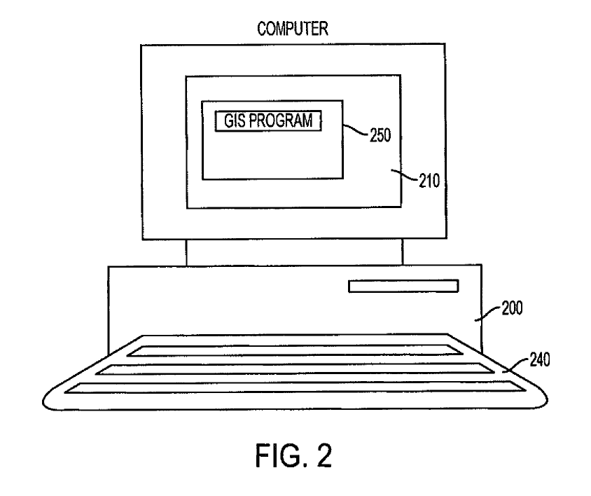

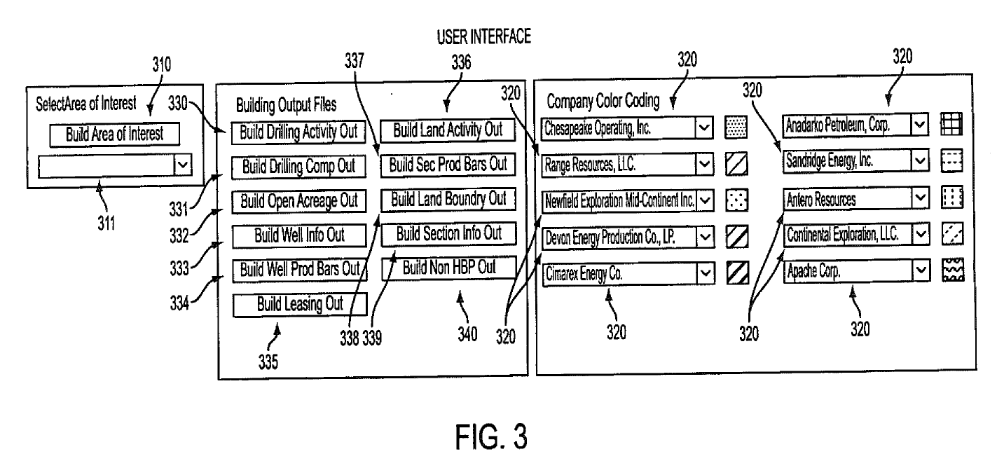

The embodiments of this application may be executed on a computer as shown in FIG. 2. This figure shows a computer which enables interaction and display of the method using an interface as detailed in FIG. 3 and the output, which can be viewed by a commercially available GIS viewer. In order to utilize the interface/method as displayed in FIG. 3, a user may utilize a computer 200 similar to that which is shown in FIG. 2. Additionally, the method described assumes that the interface in FIG. 2 is linked to a database (local or otherwise) which enables the user to select recordsets from the data outlined in data structures as shown in FIGS. 5, 5A, 8, 14, 15, 16, 29, 32 and 33. The computer 200 shown in FIG. 2 includes at least a display 210, a processing unit, 220, memory 230, an input device 240, and a geographical information system or equivalent 250.

Method of Overview

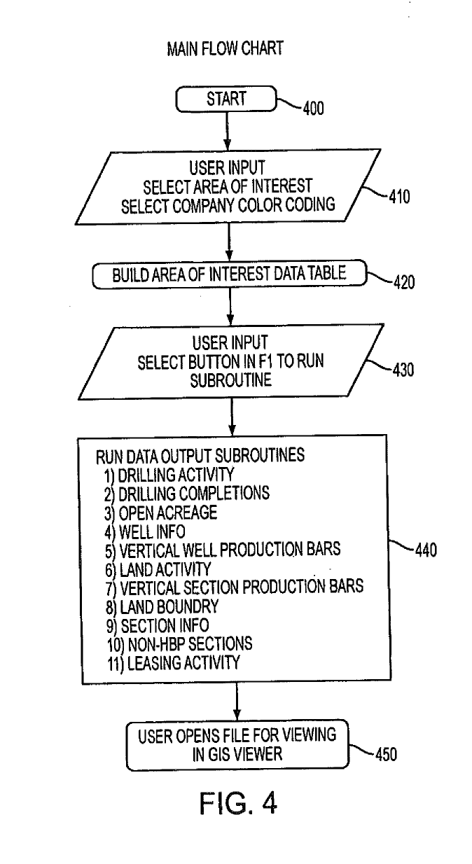

FIG. 4 represents the flow diagram of the overall process being employed and described. The application is started within the computer outlined in FIG. 2. Once the application is started 400, the user can see the user interface with “buttons” or input regions being graphical, text, or otherwise as represented in FIG. 3.

The user interface is designed to enable the user to input their area of interest 310 and their company color coding preferences 320, both of these inputs correspond to 410. An “Area of Interest” can be selected from the drop-down combo-box 311 and refer to a county or area of state for which the user would like to build output files for. Company color coding information entails the matching of company names from drop-down combo-boxes 320, with colors which the user would like to use to designate companies. Company color coding is used so that output files will properly enable the user to track a particular company's activity.

Once these pieces of information are specified 310 and 320 the user can then select “Build an Area of Interest” 420. Selecting a user's area of interest, stores section information, latitude, and longitude coordinates or any other related location identifiers, as identified, for example, in FIG. 5, 501, 502, 503, 504, and 505. All sections in a users “Area of Interest” are stored in this table, to enable easy referencing for additional output and executable operations.

Once an “Area of Interest” has been stored, a user may undertake any one of 11 operations to begin generating output files which can be ready by a GIS software package. These operations are identified as subroutines in FIG. 4 as 440. To execute these operations/subroutines (which are described in further detail below), a user clicks on buttons or input regions 330, 331, 332, 333, 334, 335, 336, 337, 338, 339, and 340 as described by 430.

Finally, once the output files have been built, the user may open the output files in a GIS viewer (as indicated by 450). This enables the user to view the files generated by this method in three-dimensions (3-D) and access all of the data outputted and analyzed in steps. Additionally, the underlying data can also be exported to a spreadsheet/csv/text file in this step.

Drilling Activity Output File

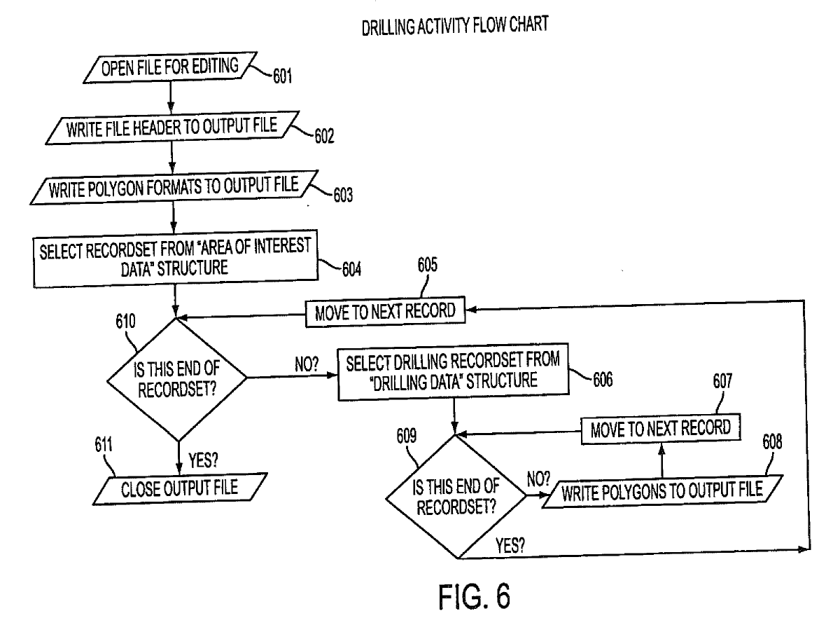

The first such output file/process that shall be described is outlined in FIG. 6, and initiated by a user clicking 330. This output file is the “Drilling Activity” output file, and is designed to output information regarding intent to drills (drilling permits), spud reports, completions, recompletion applications, and enhanced recover filings.

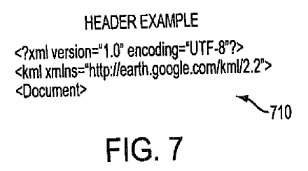

As shown in FIG. 6, the first step identified in this method is to open an output file for editing 601. Once the editable file is open, file headers are then written into the file, which enables GIS software to property identify what it is reading. A header example is shown in FIG. 7, in this instance, this particular header, 710 is used when the method is adapted to Keyhole Markup Language (KML), however, this method is also applicable to headers for other types of GIS viewers including Microsoft Virtual Earth, and ArcGIS. The drilling activity will be displayed as distinct polygons, and the formats of these polygons are written to the output file so that the GIS software will know what colors and styles of polygons are available to it. For the case of the “Drilling Activity” file, the colors that will be used are the company color codes that the user has identified in 320. Any information that is output will be based off of these user preferences. In the event that activity occurs without a designated color to map to, the polygon is shaded gray.

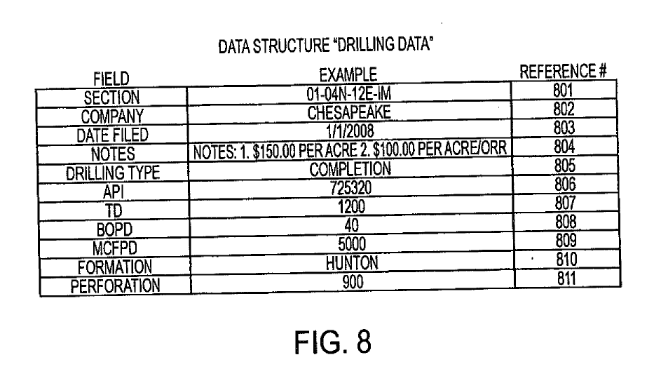

As shown in 604, a recordset is selected from FIG. 5, this recordset is comprised of all sections in a user's area of interest. Selecting all sections enables the method to loop through each of the sections in a user's “Area of Interest,” and check whether there is any activity in that section by querying “Drilling Data” of FIG. 8. The querying of the data in FIG. 8 is designated as 606. If this query in null, that is, if it is at the end of its recordset, then the method proceeds to move on to the next section to see if there is any drilling activity (permits, spuds, completions) in that section, this is identified as 609 and 605. Alternatively, if the query that is returned is not null, then the method proceeds to write to the output file.

The information that is written to the output file is based on the user preferences in 320 (the color coding) and 802 (company name), the latitude and longitude coordinates specified in 502-505, and the drilling type 805. Based on 805, the shape to be drawn is determined. In the case that a permit has been filed, then coordinates for a triangle are written to the output file (centered on 502-505). In the case that a well has been spuded, then coordinates for a half circle are written to the output file (centered on 502-505). In the case that well has been completed, then coordinates for a circle are written to the output file (centered on 502-505). Colors are also written based on the user preferences in 320, the company name is 802, as designated by the styles written in 603. The writing of the polygons to the output files is all conducted in 608.

In the event that there are multiple types of drilling activity being conducted in a particular section, the method in 608 writes a time stamp based on 803, so that if a time lag feature is available in the GIS viewer, then the viewer will know when to display the polygons of interest. As shown indicated by 607 and 609, each record of drilling information is looped through for a particular section, until the end of the recordset is reached.

Based on the processes identified in 605, 606, 607, 608, 609, and 610, each drilling record in a user's “Area of Interest” should be cycled through, enabling this information to be written to an output file. Once this task is completed, after all sections have been cycled through 610, then the output file is closed, and ready to be viewed by a commercially available GIS viewer.

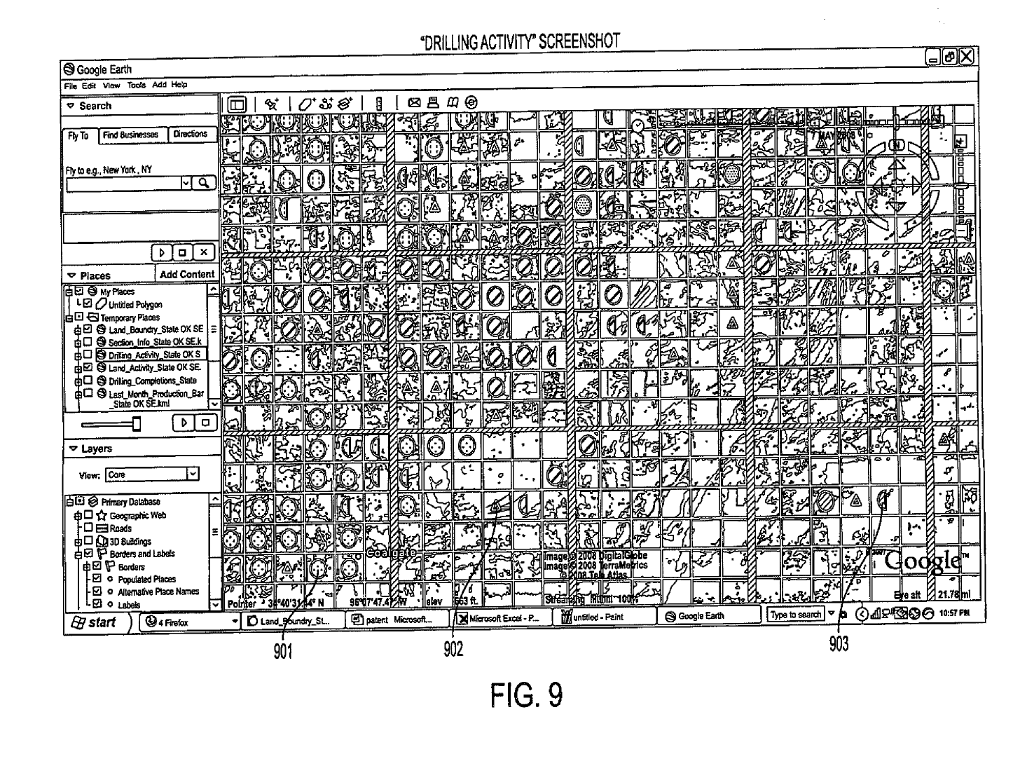

An example of how the output file is viewed in a GIS application can be seen in FIG. 9. As shown in 901, a completion is signified by a full circle, because the circle is gray it means that a user did not select this company for a specific floor in 320. As shown in 902, an intent to drill (or permit) is displayed as a small triangle, because this triangle is yellow, it means that a user selected this company in 320. As shown in 903, a spuded well is displayed as a half circle, because this half circle is yellow, it means that a user selected this company in 320.

Drilling Completions Output File

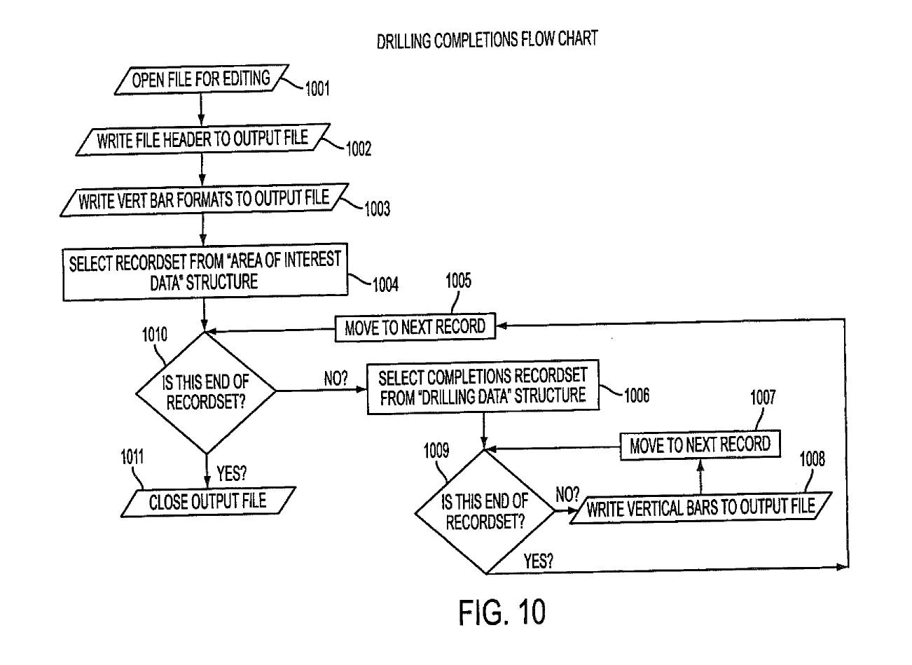

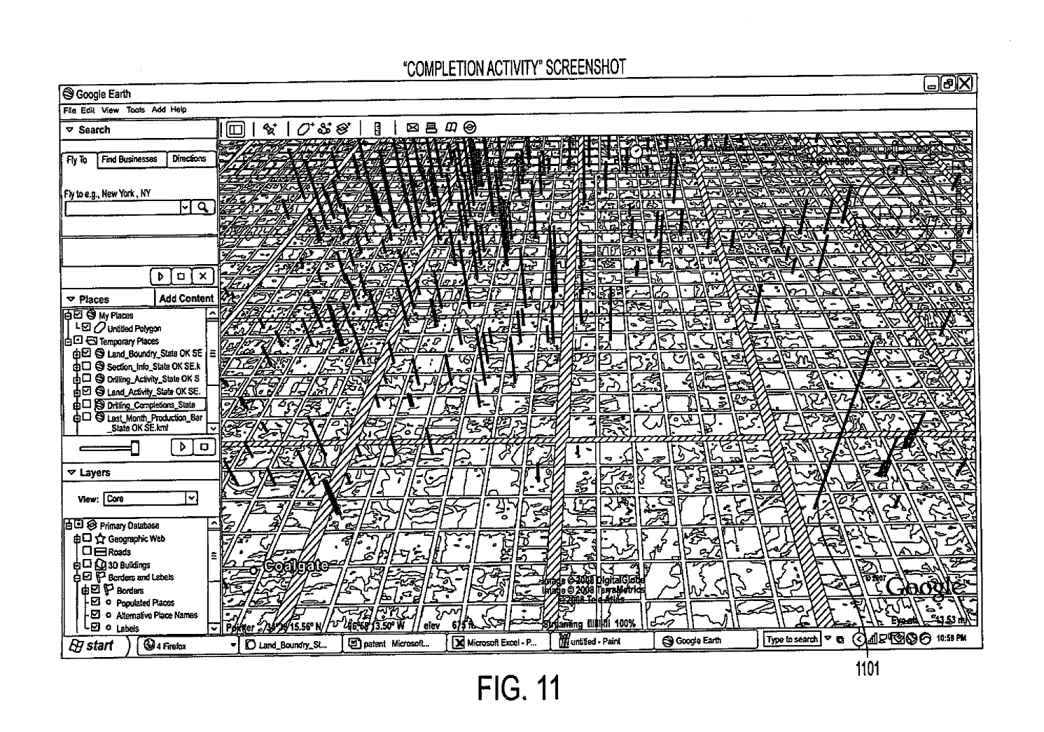

This output file/process is described in FIG. 10, and is initiated by a user clicking 331. This output file is the “Drilling Completions” output file, and is designed to output information regarding the attractiveness of drilling completions. When read by a GIS viewer, this output file should generate a series of vertical bars, corresponding to the initial production filed in a completion report. The higher the vertical bar, the more attractive the completion, the lower the vertical bar, the less attractive the completion. Vertical bars are comprised of red and green regions, the red region signifies gas production, the green region signifies oil production. The bars are designed to be comparable to one another on a British thermal unit (Btu) equivalent basis. An example of what the output looks like when viewed in a GIS viewer can be seen in FIG. 11, where 1101 points to a particular completion (red bard), whose height is determined by initial production rates.

As shown in FIG. 10, the first step identified in this method is to open an output file for editing 1001. Once the editable file is open, file headers are then written into the file, this enables GIS software to properly identify what it is reading. The drilling completions will be displayed as distinct vertical bars, the formats of these bars are written to the output file so that the GIS software will know what colors and styles of vertical bars are available to it (in this case red and green). The writing styles to the output file is signified by 1003.

As shown in 1004, a recordset is selected from FIG. 5, this recordset is comprised of all sections in a user's area of interest. Selecting all sections enables the method to loop through each of the sections in a user's “Area of Interest,” and check whether there are completions that section by querying the data structure related to “Drilling Data” in FIG. 8, and seeing whether for any records from FIG. 8 if 805 is a “completion”. The querying of Drilling Data is designated as 1006. If this query is null, that is, if it is at the end of its recordset, then the method proceeds to move on to the next section to see if there are any completions, this is identified as 1009 and 1005. Alternatively, if the query that is returned is not null, then the method proceeds to write to the output file.

The information that is written to the output file is based on the latitude and longitude coordinates specified in 502-505, the drilling type 805 (in this case completion), and the initial production volumes identified in 807 and 808. Coordinates from 502-505, are written to the output file, so that the location of the section of the completion can be identified, the height of the vertical completion bar is designated by the values of 807 and 808, the larger these values, the greater the height of the bars. The writing of the vertical completion bars to the output files is all conducted in 1008.

In the event that there are multiple completions in a particular section, the method in 1008, writes a time stamp based on 803, so that if a time lag feature is available in the GIS viewer, then the viewer will know when to display the polygons of interest. As shown indicated by 1007 and 1009, each record of drilling information is looped through for a particular section, until the end of the recordset is reached. Because the exact coordinates of the completion may not be known, this method writes coordinates to the output file, such that the completion should appear in the center of the section. In the case that there are multiple completions, not only will they be time stamped, but they will be spaced across a section.

Based on the processes identified in 1005-1010, each completion record in a user's “Area of Interest” should be cycled through, enabling this information to be written to an output file. Once this task is completed, after all sections have been cycled through 1010, then the output file is closed, and ready to be viewed by a commercially available GIS viewer.

Open Acreage Output File

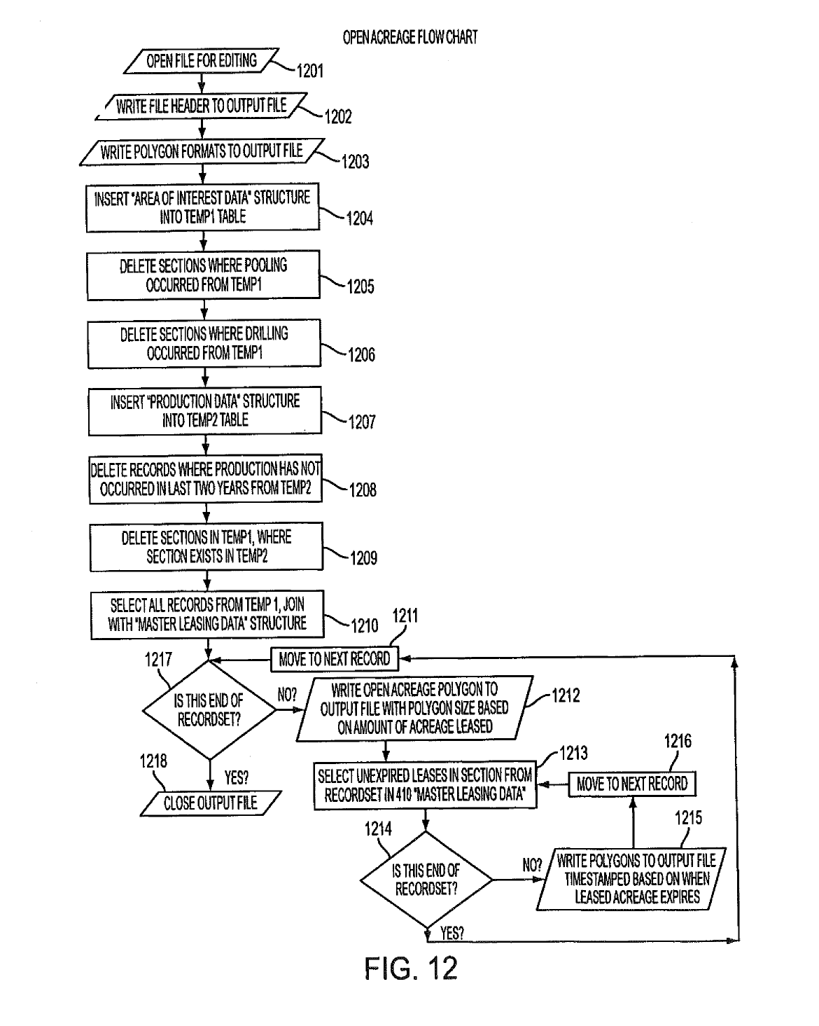

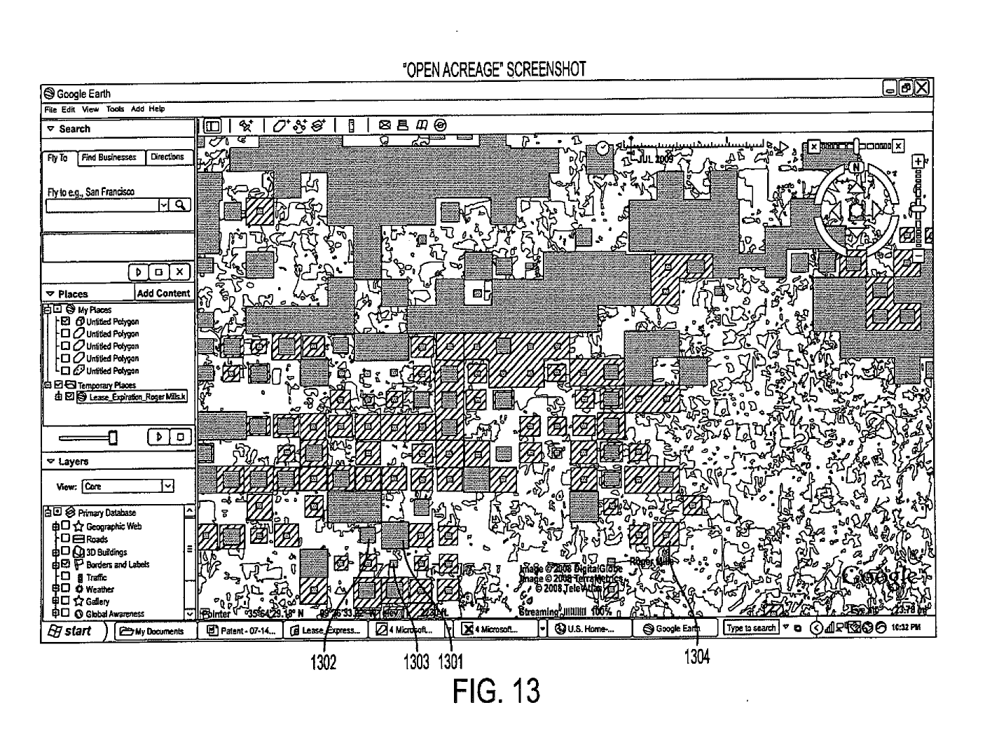

This output file/process is shown in FIG. 12, and is initiated by a user clicking 332. This output file is the “Open Acreage” output file, and is designed to output information regarding whether acreage might be available to be newly leased. When read by a GIS viewer (as can be seen in FIG. 13), this output file should generate a series pink polygons (indicated by 1301, 1302, and 1303), which signify that a section of acreage may have unleased acres. Additionally, green polygons are generated to represent previously leased acreage that has expired. Pink polygons vary in size depending on the amount of leased acreage. The largest pink polygon signifies that no acreage has been leased 1301, the medium polygon signifies that some acreage has been leased 1302, and the smallest polygon signifies that all acreage may be leased 1303.

As shown in FIG. 12, the first step identified in this method is to open an output file for editing 1201. Once the editable file is open, file headers are then written into the file, this enables GIS software to properly identify what is reading. The open acreage will be displayed as distinct pink polygons. The writing of styles to the output file is signified by 1203.

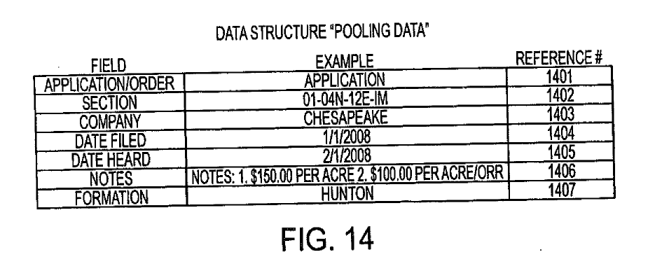

As shown in 1204, a temporary table (Temp1) is generated from the data in FIG. 5, this table is comprised of all sections in a user's area of interest, and has an identical data structure as shown in FIG. 5. Records are deleted from Temp1, based on whether there has been recent pooling activity (the section is also in FIG. 14, 1402), or whether there has been recent drilling activity (the section in 801). These processes are identified as 1205 and 1206, respectively.

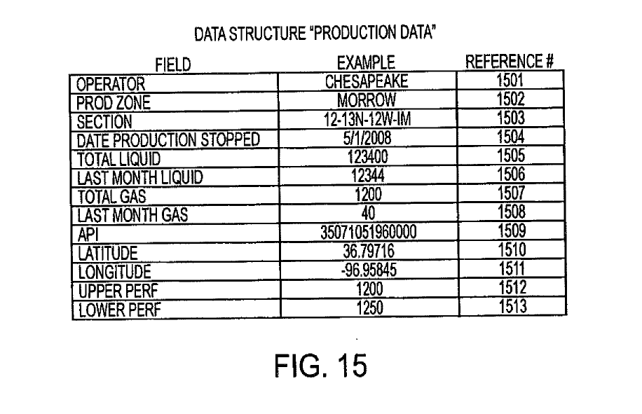

As shown in 1207, and additional temporary table is generated, but this one is from FIG. 15. This temporary table (Temp2), has the same data structure as FIG. 15. From this table, all records are deleted for which production has not occurred in the last two years as designated by 1504, this is represented by 1208.

Now that both Temp1 and Temp2 have been generated, all records from Temp1 are deleted for which a section in Temp1 exists in Temp2 (1503 is also in 501), this is represented by 1209. What this achieves is that all sections for which no production has occurred in the last two years are deleted from Temp1.

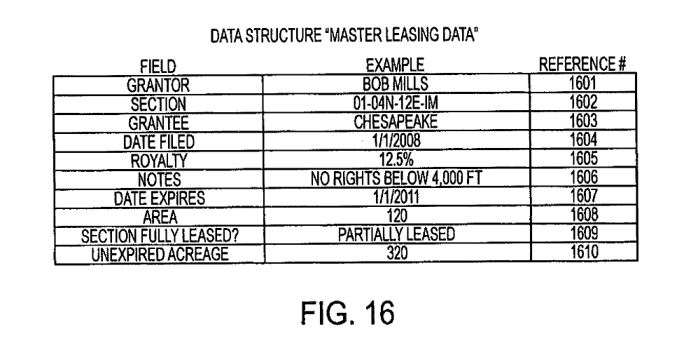

Selecting all records from Temp1 enables the method to loop through each of the sections in a user's “Area of Interest,” which have met the requirements to be open acreage; that is no pooling activity, no drilling activity, and no production in the last two years. The method proceeds to write the latitude and longitude coordinates to the output file and polygon styles, as signified in 1212. Additionally, because Temp1 has been joined with the data in FIG. 16, leasing information can be incorporated into the “Open Acreage” information. Depending on the amount of leasing done in a section, the size of the outputted pink polygon may vary. Acreage that appears to be fully leased is designated with a small pink square, acreage that is partially leased is designated with a medium pink square, and acreage that is open is designated with a full pink square (indicated by 1303, 1302, and 1301 respectively). Once these polygons are written, the method selects all leases which are unexpired for a particular section from the data in FIG. 16 (1213), then timestamps green polygons (1215) which are drawn to represent acreage becoming open after leases expire 1304. Once we have moved through all unexpired leases in a particular section 1216, we then move the next open acreage section/record 1211 and cycle through all records which have been identified as open acreage, until the end of the recordset is reached 1217. Once this task is completed, after all sections have been cycled through, then the output file is closed, and ready to be viewed by a commercially available GIS viewer.

Well Info Output File

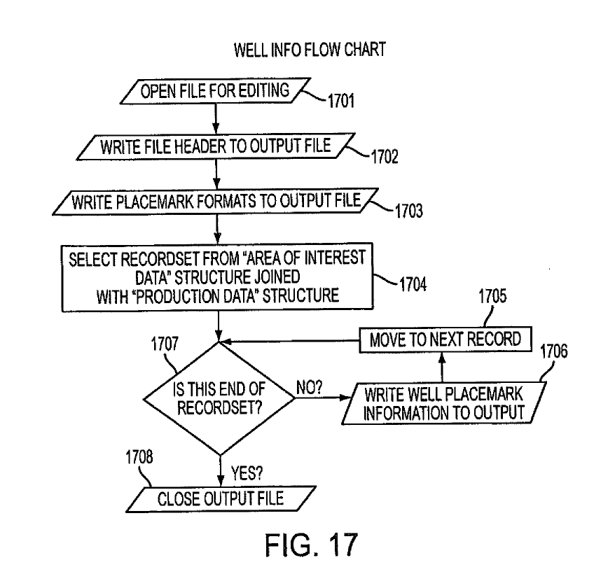

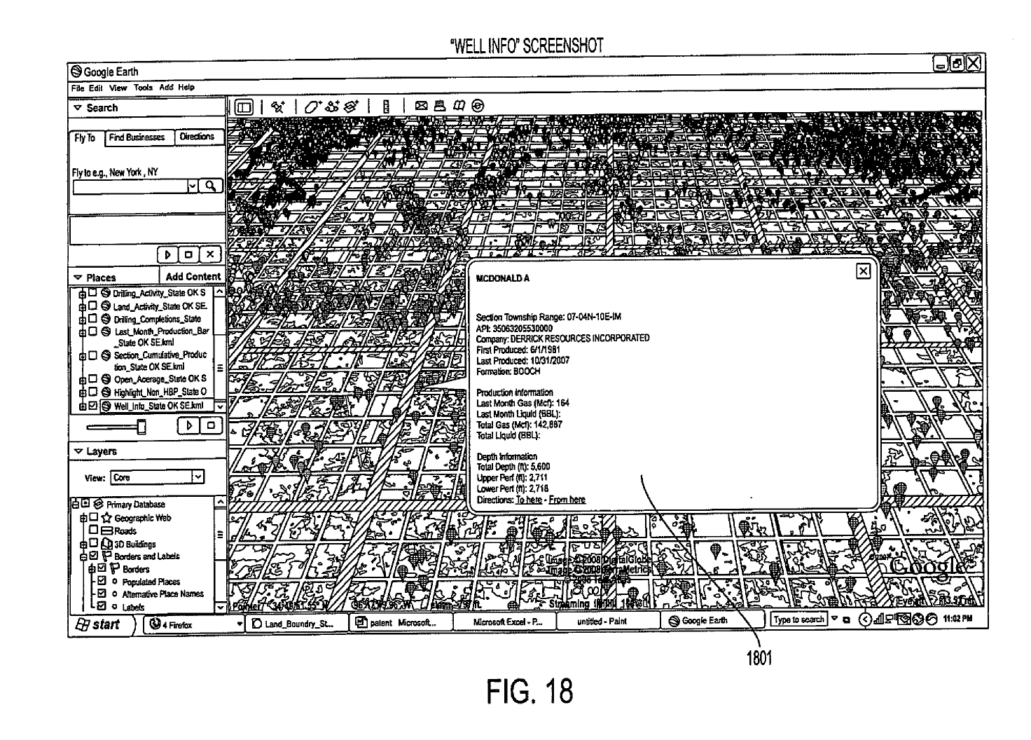

The output file/process is described as shown in FIG. 17, and is initiated by a user clicking 333. This output file is the “Well Info” output file, and is designated to output information regarding well information. When read by a GIS viewer, this output file should generate a series of placemarks, which contain information regarding operator name, API number, gas production, oil production, well depth, formation, date production start, date production stop. Additionally, the placemark colors can be shaded depending on the date of production stopping. An example of the output, when viewed by a GIS viewer can be seen in FIG. 18, with an example of detailed well information being displayed in 1801.

As shown in FIG. 17, the first step identified in this method is to open an output file for editing 1701. Once the editable file is open, file headers are then written into the file, this enables GIS software to properly identify what it is reading. The well information will be displayed as distinct placemarks, the formats of these placemarks are written to the output file so that the GSI software will know what colors and styles of placemarks are available to it (in this case red for active wells and blue for inactive). The writing of styles to the output file is signified by 1703.

As shown in 1704, a recordset is selected from FIG. 5 and FIG. 15, this recordset is comprised of all sections in a user's area of interest and production information. Selecting all sections and wells in an area of interest enables the method to loop through each of ns in a user's “Area of Interest.” Once the recordset has been created, as represented by 1704, this method then checks whether the end of the recordset has been reached. If the end of the recordset has not been reached, the method utilizes the information in the recordset (same date structures as in FIGS. 5 and 15) to write an output file, such that this information can then be represented in a GIS viewer, utilizing the well information and latitude and longitude coordinates from FIGS. 5 and 15. The process of checking whether the end of the recordset has been reached, the writing of information to the output file, and moving to the next record is represented by 1708, 1707, and 1706.

Once this task is completed, after all sections have been cycled through 1708, then the output file is closed 1709, and ready to be viewed by a commercially available GIS viewer.

Vertical Well Production Bar Output File

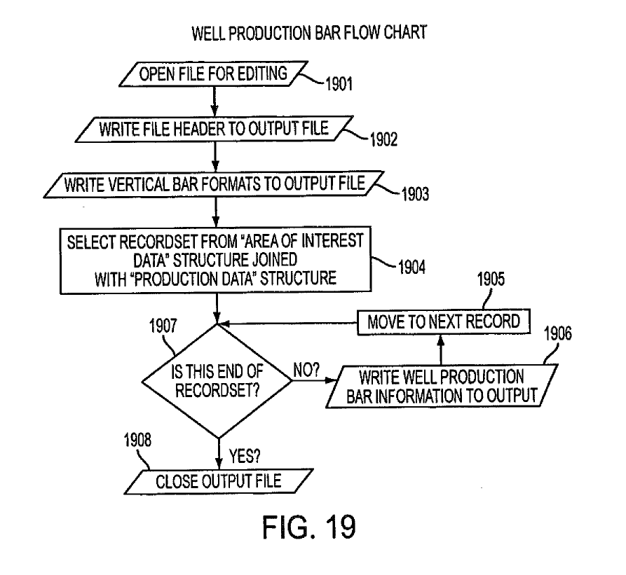

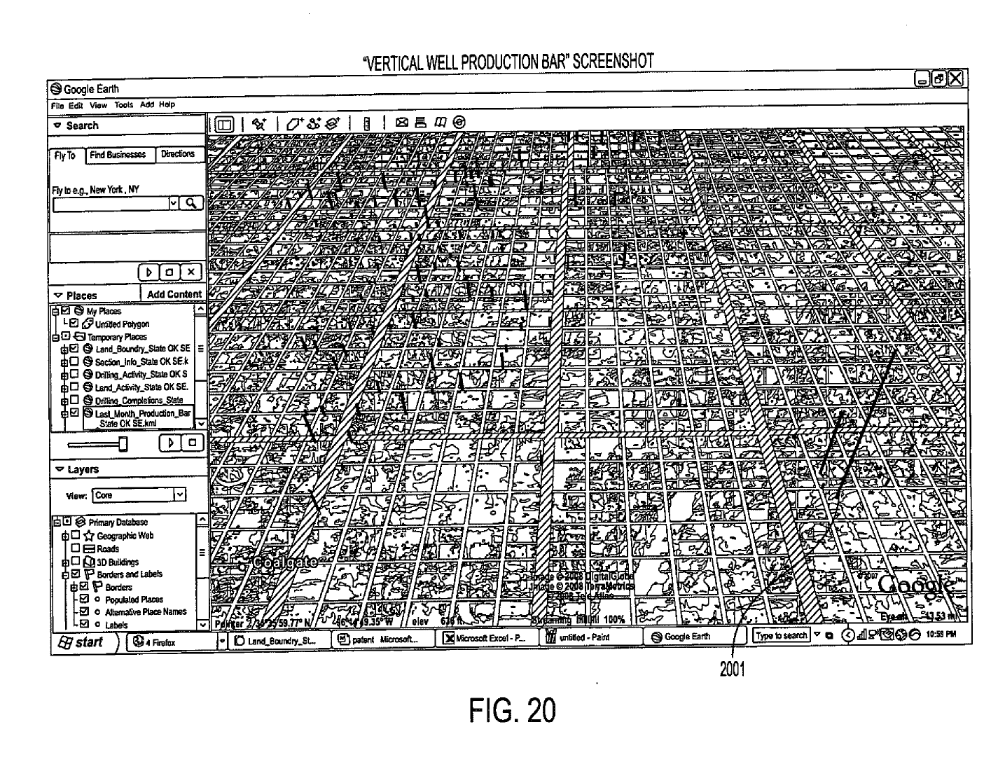

This output file/process is described in FIG. 19, and is initiated by a user clicking on 334. This output file is the “Vertical Well Production Bar” output file, and is designed to output information regarding the well volume information. When read by a GIS viewer, this output file should generate a series of vertical bars, corresponding to the last month production volume. The higher the vertical bar, the more attractive the completion, the lower the vertical bar, the less attractive the completion. Vertical bars are comprised of red and green regions, the red region signifies gas production, the green region signifies oil production. The bars are designed to be comparable to one another on a Btu equivalent basis. An example of the output, when viewed by a GIS viewer, can be seen in FIG. 20, in this case 2001 is pointing to a particular well with gas (red bar) production.

As shown in FIG. 19, the first step identified in this method is to open an output file for editing 1901. Once the editable file is open, file headers are then written into the file, this enables GIS software to properly identify what is reading. The production volume will be displayed as distinct vertical bars, the formats of these bars are written to the output file so that the GIS software will know what colors and styles of vertical bars are available to it (in this case red and green). The writing of styles to the output file is signified by 1903.

As shown in 1904, a recordset is selected from FIG. 5 and FIG. 15, this recordset is comprised of all sections in a user's area of and interest and wells from a user's area of interest. Selecting all sections and wells in an area of interest enables the method to loop through each well in a user's “Area of Interest.” Once the recordset has been created, as represented by 1904, this method then checks whether the end of the recordset has been reached 1907. If the end of the recordset has not been reached, the method utilizes the information in the recordset (same data structures as FIG. 5 and FIG. 15) to write to an output file, such that this information can then be represented in a GIS viewer. The information written in 1906, is from the recordset which contains data in FIG. 5 and FIG. 15. FIG. 5 and FIG. 15 contain information on latitude, longitude, gas production and liquid production. This enables a GIS viewer to accurately reflect the production volumes of wells. The process of checking whether the end of the recordset has been reached, the writing of information to the output file, and moving to the next record is represented by 1908, 1907, and 1906.

Once this task is completed, after all sections have been cycled through 1906, then the output file is closed 1908, and ready to be viewed by a commercially available GIS viewer.

Land Activity Output File

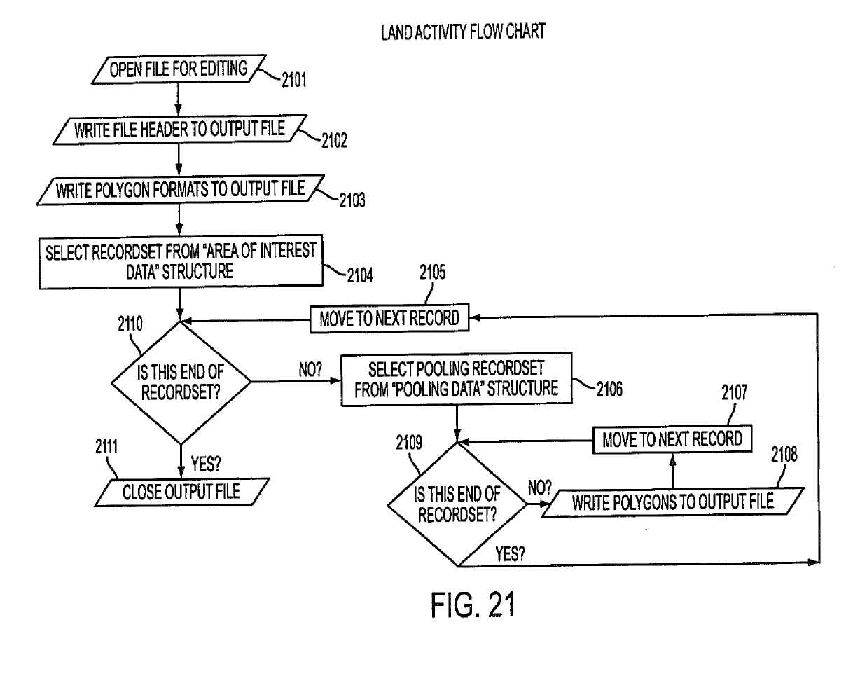

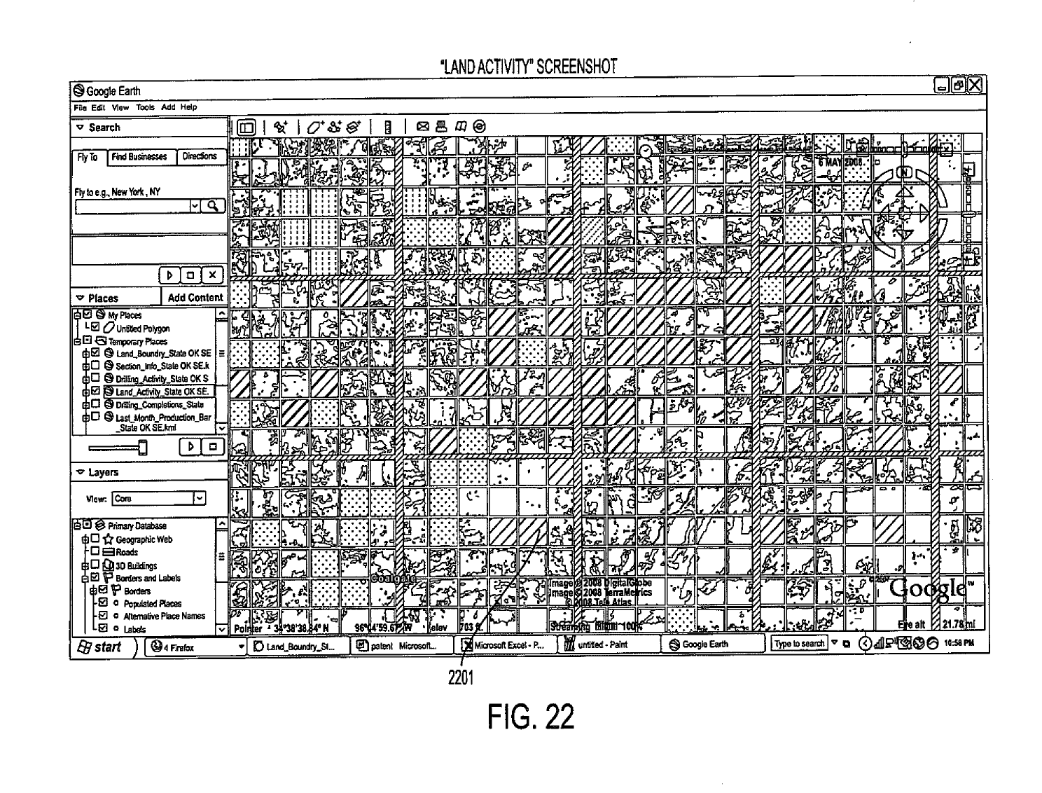

This process is initiated by a user clicking on 335. As shown in FIG. 21, the first step identified in this method is to open an output file for editing 2101. Once the editable file is open, file headers are then written into the file, this enables GIS software to properly identify what is reading. The land activity will be displayed as distinct polygons (representing pooling), the formats of these polygons are written to the output file so that the GIS software will know what colors and styles of polygons are available to it. For the case of the “Land Activity” file, the colors that will be used are the company color codes that the user has identified in 320. Any information that is output will be based off of these user preferences. In the event that activity occurs without a designated color to map to, the polygon is shaded gray. An example of the output being viewed in a GIS viewer in FIG. 22 shows the land activity polygons. As shown by 2201, pooling/land activity is represented by polygons of various colors.

As shown in 2104, a recordset is selected from the data of FIG. 5, this recordset is comprised of all sections in a user's area of interest. Selecting all sections enables the method to loop through each of the sections in a user's “Area of Interest,” and check whether there is any activity in that section by querying “Pooling Data” shown in FIG. 14. The querying of the pooling data of FIG. 14 is designated as 2106. If this query is null, that is, if it is at the end of its recordset, then the method proceeds to move on to the next section to see if there is any pooling activity in that section, this is identified as 2109 and 2105. Alternatively, if the query that is returned is not null, then the method proceeds to write to the output file.

The information that is written to the output file is based on the user preferences in 320 (the color coding) and 1403 (company name), the latitude and longitude coordinates specified in 502-505. In the case that a pooling document has been filed, then coordinates for square is written to the output file (centered on 502-505). Colors are also written based on the user preferences in 320, the company name 1403, as designated by the styles written in 2103. The writing of the polygons to the output files is all conducted in 2108.

In the event that there are multiple pooling documents filed in a particular section, the method in 2108, writes a time stamp based on 1404, so that if a time lag feature is available in the GIS viewer, then the viewer will know when to display the polygons of interest. As shown indicated by 2107 and 2109, each record of land information is looped through for a particular section, until the end of the recordset is reached.

Based on the processes indentified in 2105-2110, each land record in a user's “Are of Interest” should be cycled through, enabling this information to be written to an output file. Once this task is completed, after all sections have been cycled through 2110, then the output file is closed 2111, and ready to be viewed by a commercially available GIS viewer.

Vertical Section Production Bar Output File

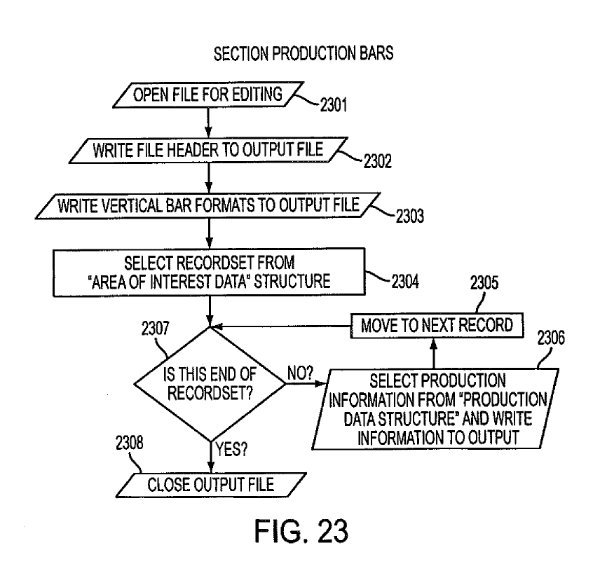

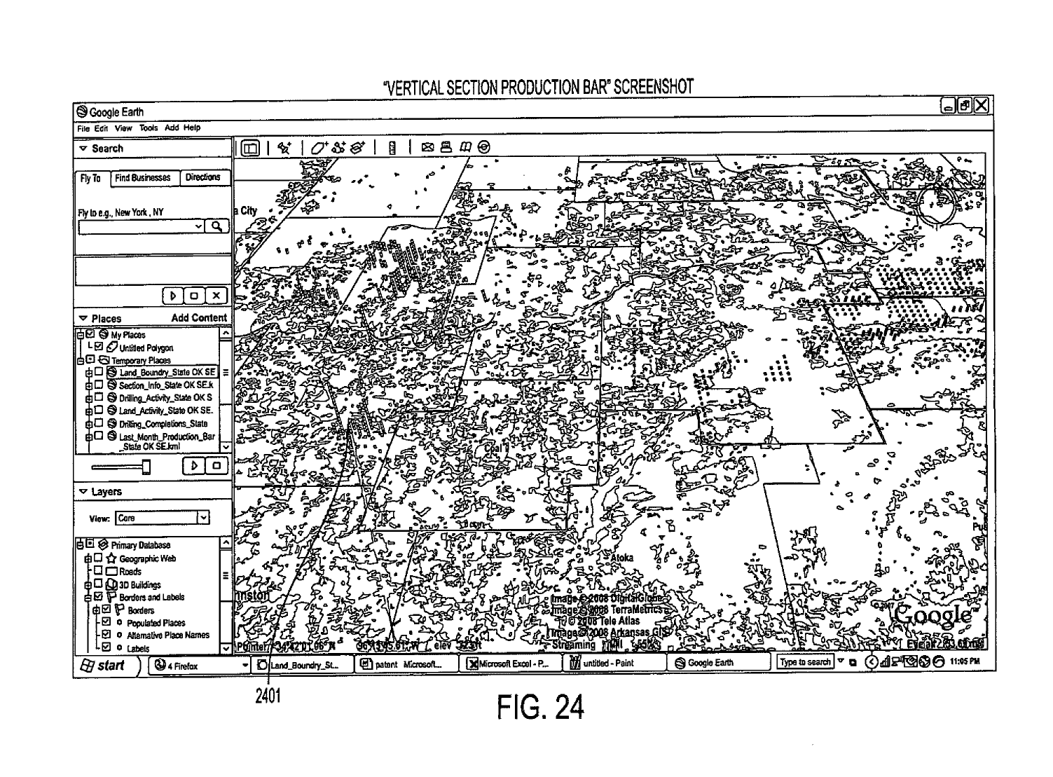

The output file/process is described in FIG. 23, and is initiated by 336. This output file is the “Vertical Section Production Bar” output file, and is designed to output information regarding cumulative section production information. When read by a GIS viewer, this output file should generate a series of vertical bars, corresponding to the cumulative production is a particular section. The higher the vertical bar, the more production, the lower the vertical bar, the less the production. Vertical bars are comprised of red and green regions, the red region signifies gas production, the green region signifies oil production. The bars are designed to be comparable to one another on a Btu equivalent basis. An example of the output, when viewed by a GIS viewer can be seen in FIG. 24. In this example, 2401 is a section with oil (green) production.

As shown in FIG. 23, the first step identified in this method is to open an output file for editing 2301. Once the editable file is open, file headers are then written into the file, this enables GIS software to properly identify what it is reading. The production volumes will be displayed as distinct vertical bars, the formats of these bars are written to the output file so that the GIS software will know what colors and styles of vertical bars are available to it (in this case red and green). The writing of styles to the output file is signified by 2303.

As shown in 2304, a recordset is selected from FIG. 5, this recordset is comprised of all sections in a user's area of interest. Selecting all sections in an area of interest enables the method to cycle through each section. Once the recordset has been created, as represented by 2304, this method then checks whether the end of the recordset has been reached 2307. If the end of the recordset has not been reached, the method utilizes the information in the recordset (same data structures as in FIG. 5) to query the production data to aggregate cumulative production information for the section from FIG. 15, as represented by 2306. Information from FIG. 5 and FIG. 15 are then written to an output file, such that this information can then be represented in a GIS viewer. The information written in 2303, is from the recordset which contains data from FIGS. 5 and 15, FIGS. 5 and 15 contain information on latitude, longitude, gas production, and liquid production. This enables a GIS viewer to accurately reflect the production volumes of wells. The process of checking whether the end of the recordset has been reached, the writing of information to the output file, and moving to the next records is represented by 2305, 2307, and 2306.

Once this task is completed, after all sections have been cycled through 2307, then the output file is closed 2308, and ready to be viewed by a commercially available GIS viewer.

Land Boundary Output File

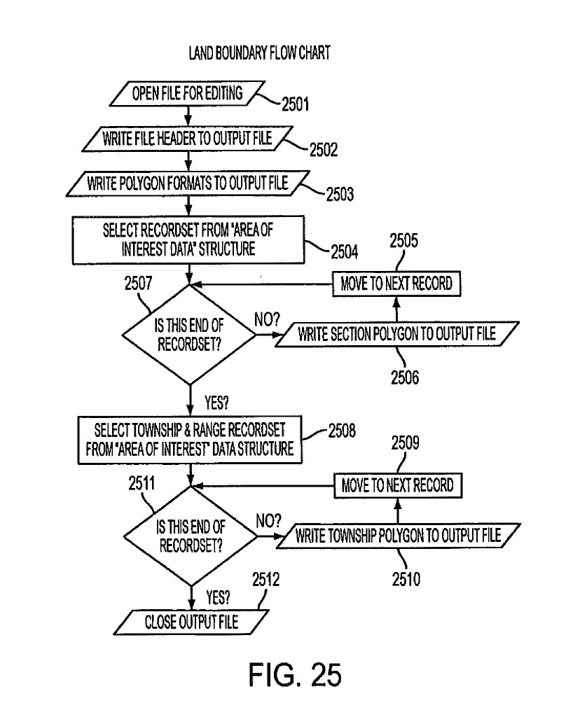

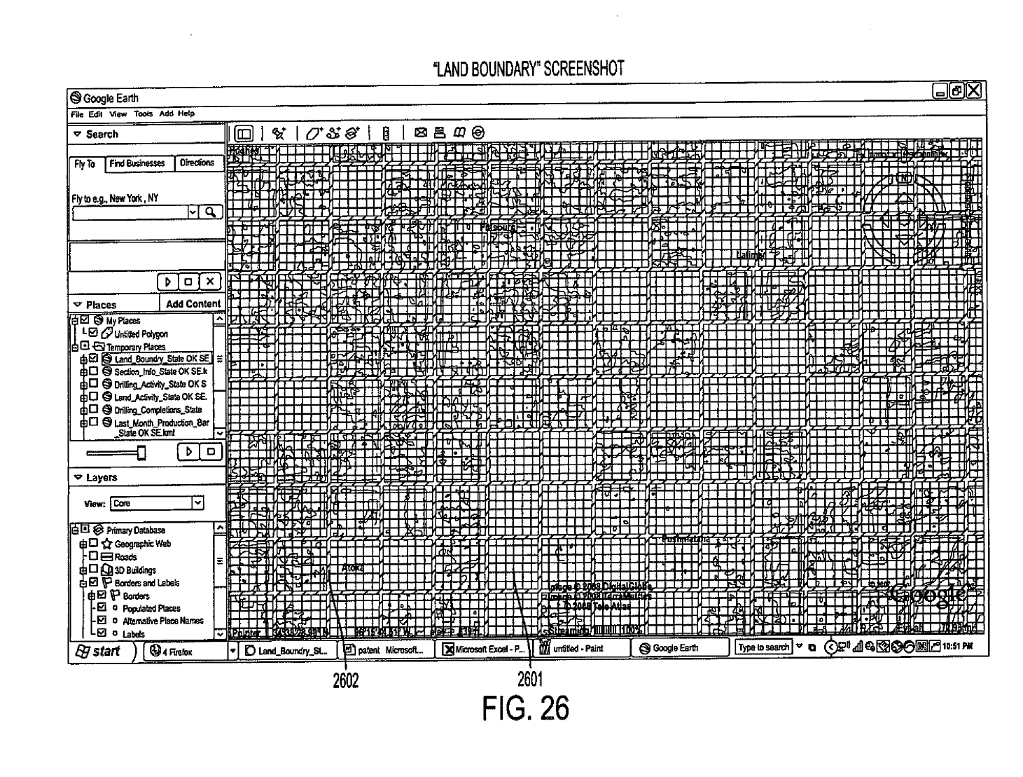

This process is initiated by a user clicking on 337. As shown in FIG. 25, the first step identified in this method is to open and output file for editing 2501. Once the editable file is open, file headers are then written into the file, this enables GIS software to properly identify what is reading. The land boundaries will be displayed as distinct polygons, the formats of these polygons are written to the output file so that the GIS software will know what colors and styles of polygons are available to it. For the case of the “Land Boundary” file, the interiors of the polygons will be transparent, and the borders of the polygons will be white (for sections) and yellow (for townships). And example of the output, when viewed by a GIS editor can be seen in FIG. 26. In this example 2601 signifies a section (transparent polygon, white border), and 2602 signifies a township (transparent polygon, yellow border).

As shown in 2504, a recordset is selected from the data in FIG. 5, this recordset is comprised of all sections in a user's are of interest. Selecting all sections enables the method to loop through each of the sections in a user's “Area of Interest,” and write section latitude and longitude coordinates 2506. The looping continues until all of the sections in a user's area of interest have been exhausted, and the end of the recordset has been reached 2507.

After all sections in a user's area of interest have been written to an output file, the township and range polygons are then written to the output file. To undertake this process township and range information is selected from a user's area of interest by selecting a recordset from FIG. 5, such that the section portion of 501 is left out, and the latitude and longitude information is aggregated. Information is then written to the output file, such that townships can be displayed when it is read by a GIS viewer. In order to cycle through all townships in a user's area of interest the process in 2509, 2510, and 2511 is undertaken, until all townships in a user's area of interest have been cycled through.

Once this task is completed, after all sections and townships have been cycled through (2507 and 2511), then the output file is closed 2512, and ready to be viewed by a commercially available GIS viewer.

Section Info Output File

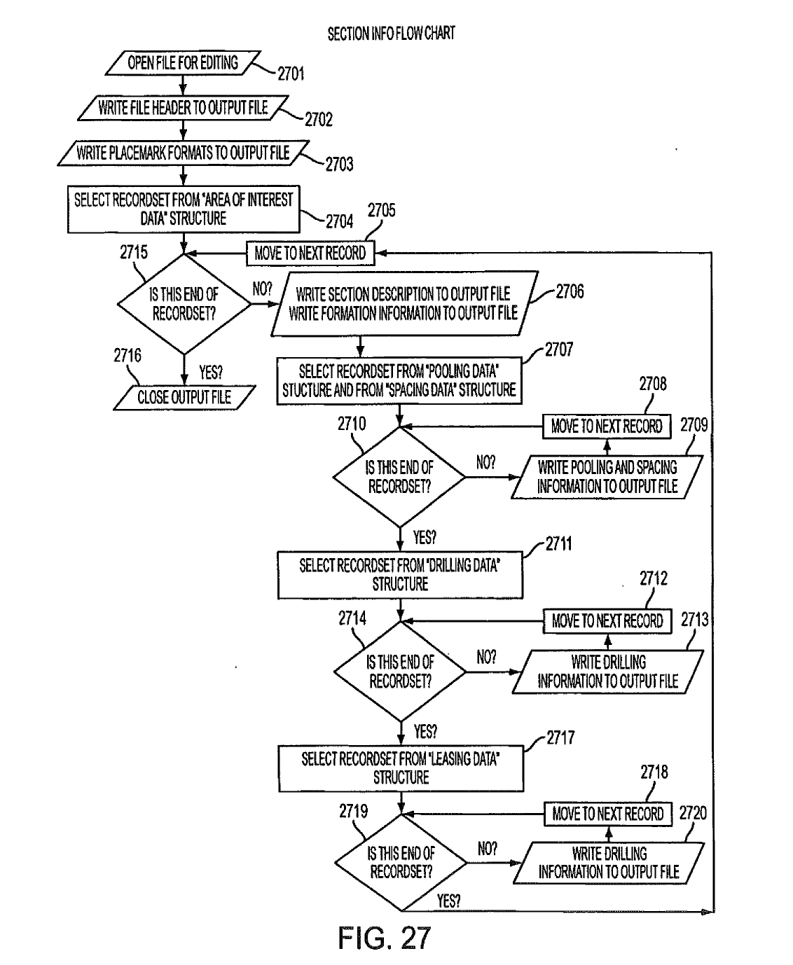

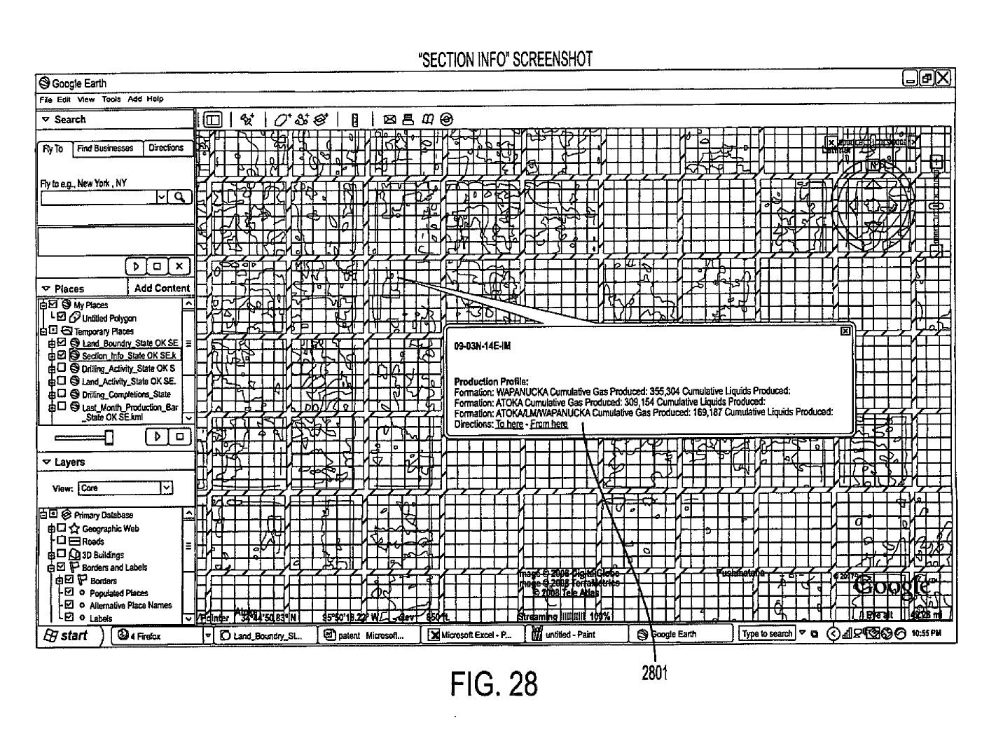

This output file/process is described in FIG. 27, and initiated by a user clicking on 338. This output file is the “Section Info” output file, and is designed to output information regarding production information, pooling information, drilling information, and leasing information. When read by a GIS viewer, this output file should generate a series of placemarks corresponding to sections, which contain information regarding aggregate production by formation, pooling records, and drilling records. An example of the output, when viewed by a GIS viewer is FIG. 28, where 2801 is an example of detailed section information being displayed.

As shown in FIG. 27, the first step identified in this method is to open an output file for editing 2701. Once the editable file is open, file headers are then written into the file, this enables GIS software to properly identify what it is reading. The section information will be displayed as distinct placemarks, the formats of these placemarks are written to the to output file so that the GIS software will know what colors and styles of placemarks are available to it. The writing of styles to the output file is signified by 2703.

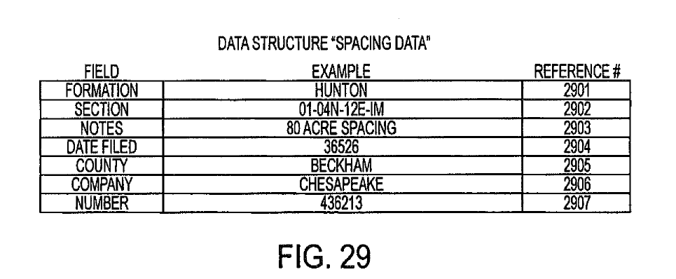

As shown in 2704, a recordset is selected from the data in FIG. 5, this recordset is comprised of all sections in a user's area of interest. Selecting all sections in an area of interest enables the method to loop through each section in a user's “Area of Interest.” Once the recordset has been created, as represented by 2704, this method then checks whether the end of the recordset has been reached. If the end of the recordset has not been reached, the method utilizes the information in the recordset (same data structures as in FIG. 5) to write to an output file information regarding aggregate production information, which is queried from D1. Then the method proceeds to check whether and pooling and spacing documents have been filed in the section by selecting a recordsets from FIG. 14 and FIG. 29. Through the process described in 2708, 2709, and 2710, the method writes all pooling and spacing documents to the output file which are related to a given section. Then the method proceeds to check whether any drilling documents have been filed in the section by selecting a recordset from FIG. 14. Through the process described in 2712, 2713, and 2714, the method writes all drilling documents to the output file which are related to a given section. Then the method proceeds to check whether any leasing documents have been filed in the section by selecting a recordset from FIG. 16. Through the process described in 2718, 2719, and 2720, the method writes all leasing documents to the output file which are related to a given section.

Once this task is completed, after all sections have been cycled through 2715, then the output file is closed 2716, and ready to be viewed by a commercially available GIS viewer.

Not Held by Production (Non-HBP) Output File

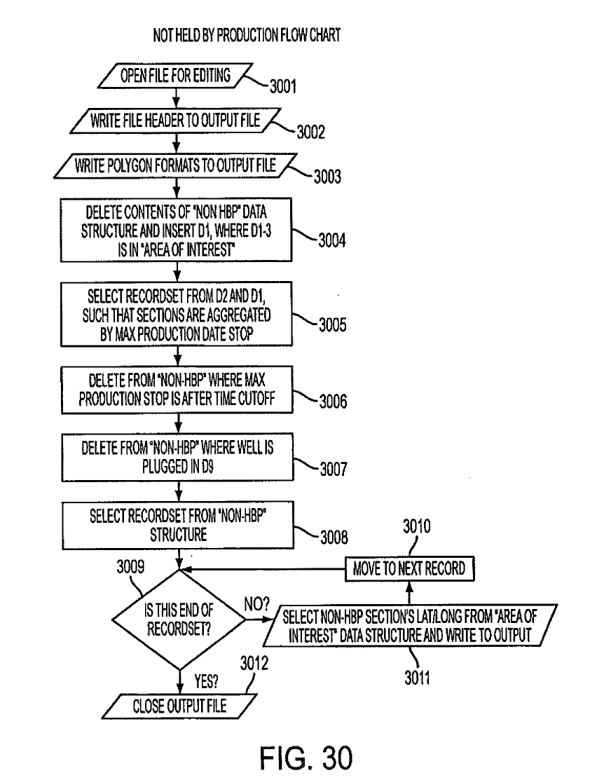

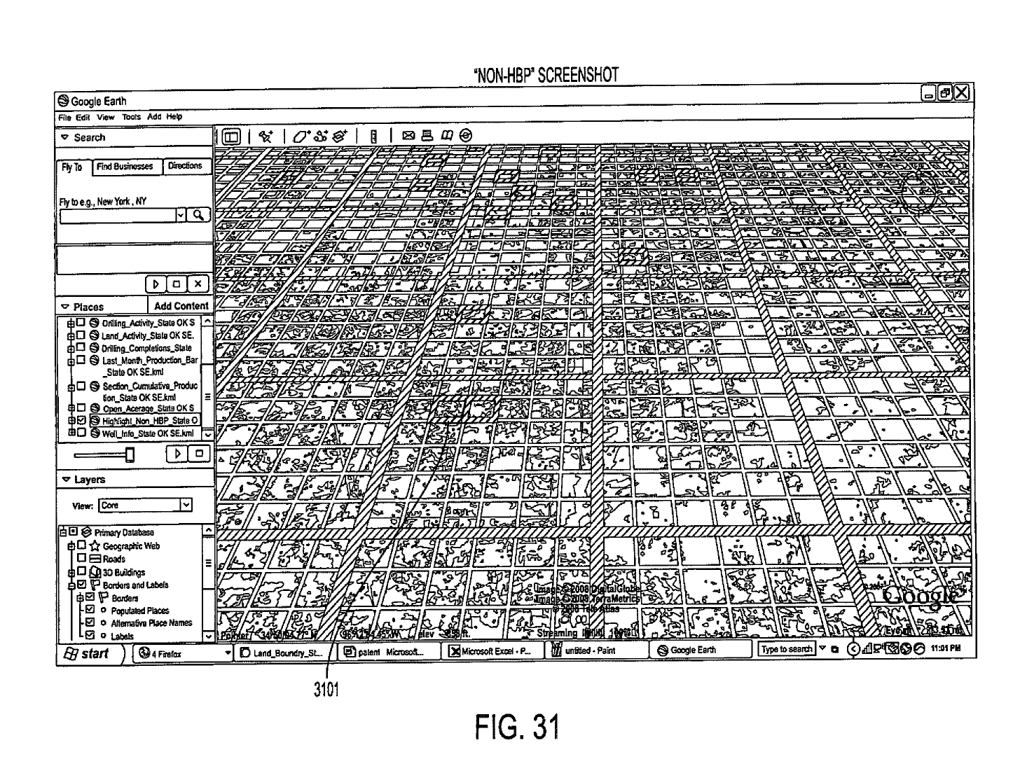

This process is initiated by a user clicking on 338. As shown in FIG. 30, the first step identified in this method is to open an output file for editing 3001. Once the editable file is open, the file headers are then written into the file, this enables GIS software to properly identify what is reading. The Non-HBP sections will be displayed as distinct polygons, the formats of these polygons are written to the output file so that the GIS software will know what colors and styles of polygons are available to it. For the case of the “Non-HBP” file, the formats are written for transparent polygons, with orange borders. A section identified as Non-HBP (Not Held By Production) indicates that all wells in a particular section have stopped production, and that a well in that particular section is not plugged. An example of the output, when viewed by a GIS viewer, can be seen in FIG. 31, with 3101 being a Non-HBP section.

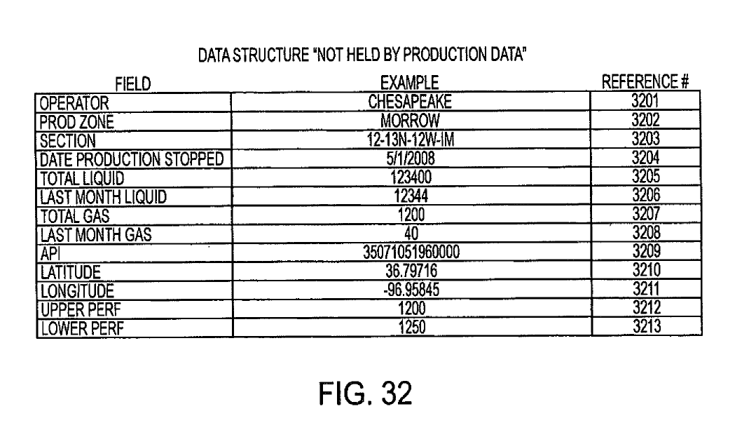

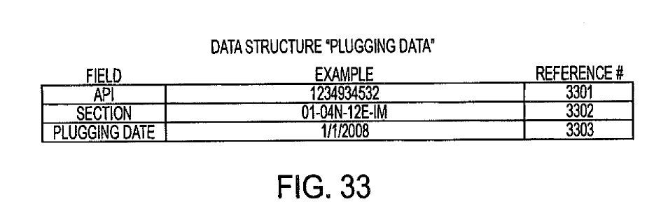

As shown in 3004, the contents of FIG. 32 are deleted, and the data of FIG. 15 is inserted into the date of FIG. 32 such that only records in FIG. 15 that are in a user's area of interest in FIG. 5 exist in FIG. 32. At this point the data of FIG. 32 consists of all the wells in a user's area of interest. As shown in 3005, a recordset is selected such that the date of last production of all wells in a section is identified. Once this recordset is identified, all sections with production in the last 2 years are deleted from FIG. 32 (3006). The all wells in FIG. 32 that are plugged (as determined by data in FIG. 33) are deleted from FIG. 32. The resultant data structure contains wells in sections with no production in the last 2 years, and which are not plugged.

As shown in 3008, a recordset is selected from the data in FIG. 32, this recordset is comprised of all Non-HBP sections in a user's area of interest. Selecting all sections enables the method to loop through each of the section. Through the method represented by 3009, 3010, and 3011, non-HBP sections are written to a user's output file when they are in a user's area of interest as represented by 3011. The recordset in 3011 also contains latitude and longitude information from FIG. 5, to enable an accurate geographic representation when viewed by a GIS application.

The method continues to cycle through all Non-HBP sections until the end of the recordset is reached (3010). Once this task is completed, after all sections have been cycled through (3009), then the output file is closed (3012), and ready to be viewed by a commercially available GIS viewer.

Leasing Activity Output File

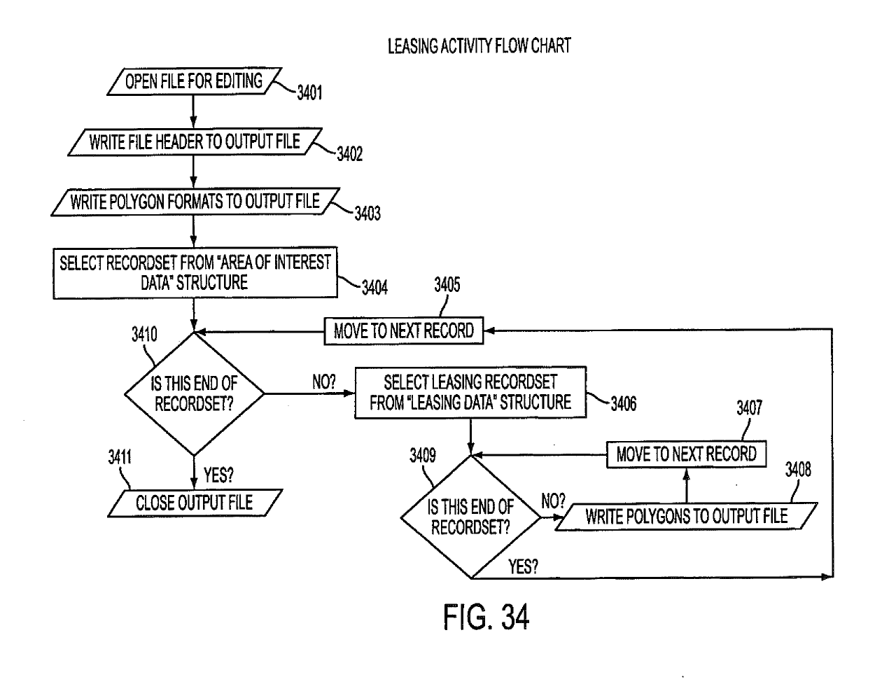

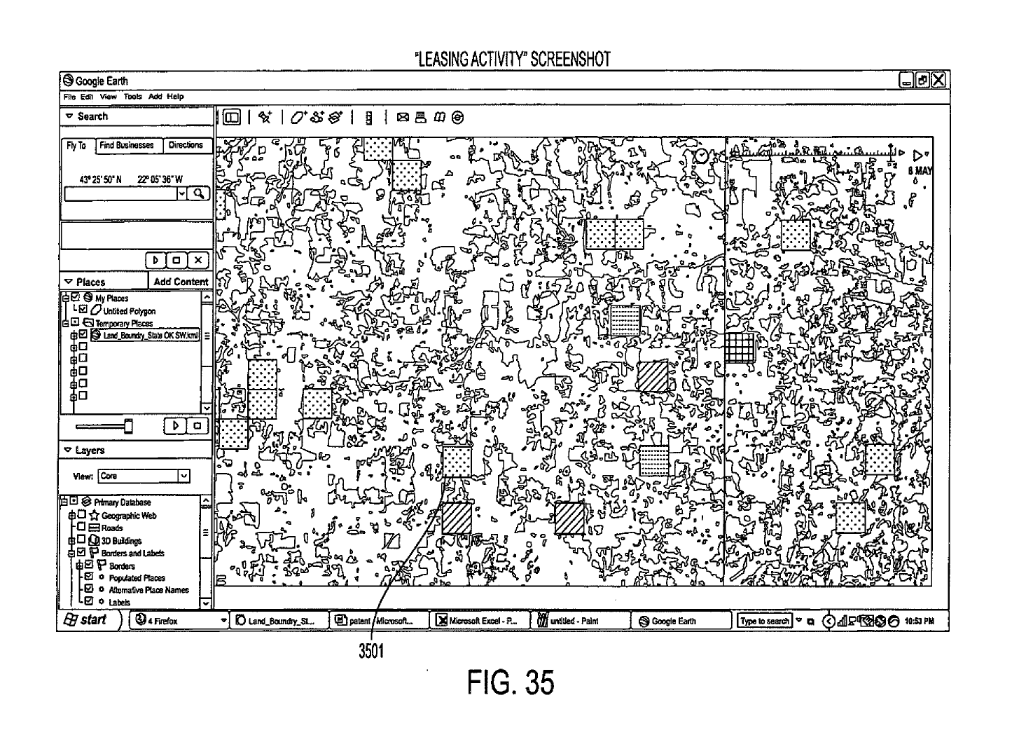

This process is initiated by a user clicking on 339. As shown in FIG. 34, the first step identified in this method is to open an output file for editing 3401. Once the editable file is open, file headers are then written into the file, this enables GIS software to properly identify what is reading. The leasing activity will be displayed as distinct polygons, the formats of these polygons are written to the output file so that the GIS software will know what colors and styles of polygons are available to it. For the case of the “Leasing Activity” file, the colors that will be used are the company color codes that the user has identified in 320. Any information that is output will be based off of these user preferences. In the event that activity occurs without a designated color to map to, the polygon is shaded gray. An example of the output being viewed in a GIS viewer in FIG. 35 shows the leasing activity polygons. As shown by 3501, pooling/land activity is represented by polygons of various colors.

As shown in 3404, a recordset is selected from the data of FIG. 5, this recordset is comprised of all sections in a user's area of interest. Selecting all sections enables the method to loop through each of the sections in a user's “Are of Interest,” and check whether there is any activity in that section by querying “Leasing Data” in FIG. 16. The querying of the data of FIG. 16 is designated as 3406. If this query is null, that is, if it is at the end of its recordset, then the method proceeds to move on to the next section to see of there is any pooling activity in that section, this is identified as 3409 and 3405. Alternatively, if the query that is returned is not null, then the method proceeds to write to the output file.

The information that is written to the output file is based on the user preferences in F1-13 (the color coding) and D7-3 (company name/grantee), the latitude and longitude coordinates specified in D2-2, D2-3, D2-4, D2-5. In the case that a leasing document has been made of record, then coordinates for square is written to the output file (centered on D2-2, D2-3, D2-4, D2-5). Colors are also written based on the user preferences in F1-13, the company name D7-3, as designated by the styles written in 1203. The writing of the polygons to the output file is all conducted in 1208.

In the event that there are multiple leases made of record in a particular section, the method in 3408, writes a time stamp based on 1604, so that if a time lag feature is available in the GIS viewer, then the viewer will know when to display the polygons of interest. As shown indicated by 3407 and 3409, each record of leasing information is looped through for a particular section, until the end of the recordset is reached.

Based on the processes identified in 3405, 3406, 3407, 3408, 3409, and 3410, each leasing record in a user's “Area of Interest” should be cycled through, enabling this information to be written to an output file. Once this task is completed, after all sections have been cycled through (3410) then the output file is closed (3411), and ready to be viewed by a commercially available GIS viewer).

Overlays

One of the primary benefits of this method is that each individual type of data is represented by an “overlay,” enabling a user to view the aspects of data they are interested in. For example, someone interested in drilling and leasing data, only needs to overlay Drilling Activity (generated as shown in FIG. 6), Drilling Completion (generated as shown in FIG. 10), Section Info (generated as shown in FIG. 27), and Leasing Activity (generated as shown in FIG. 34). There are multiple permutations and combinations that may be relevant to a user. The process described here is applicable to all permutations and combinations of the previously mentioned overlays. One example of an overlay is shown in FIG. 1, here the “Land Boundary,” “Land Activity,” “Vertical Well Production Bars” are all overlaid.

As can be seen from the above discussion, the embodiments provide a system, method, and displays for an area of interest which is selected by a user using an input device connected to a computer. The user selects an area of interest, companies, and a type of information related to oil and gas by marking, clicking, selecting, or otherwise from an interface having selectable text, buttons or input regions. The area of interest selected by the user refers to, for example, a county or area for which the user desires to generate an output file which can be input into a geographic information system. The user makes selections using the input device of a particular color to represent each of a plurality of companies. Based on the selected area of interest, section information and latitude and longitude information are obtained and stored in a storage in the computer. The user selects a type of an output file to generate based on the type oil and gas related information desired which may include a drilling activity output file, a drilling completion output file, an open acreage output file, a well information output file, a vertical well production output file, a leasing activity output file, a land activity output file, a section production bar output file, a land boundary output file, a section information output file, and a not held by production output file. Information based on the selected types of output file is then stored in the storage in the computer. An output file is generated based on the selected area of interest, companies, and the type of information desired. The output file may be a Keyhole Markup Language file (KML), KMZ file, or any other type of output file readable by a geographic information system or other system for displaying geographic related information. The output file is input into the geographic information system and a corresponding overlay related to oil and gas information is displayed in the area of interest on a two-dimensional, quasi-two dimensional, or three-dimensional map using the geographic information system.

The embodiments provide a system, method, and displays which integrate public, third party, and proprietary data which, as an example, may be related to the state of Oklahoma and the laws governed by the Oklahoma Corporation Commission, the government entity responsible for oil and gas exploration and production for Oklahoma. However, the embodiments may be modified to integrate information from any state government entity such as the State of Arkansas Oil & Gas Commission, the Pennsylvania Department of Environmental Protection, the Pennsylvania Department of Conservation and Natural Resources, the Louisiana Office of Conservation, etc. Thus, the data may be from any government entity, any third party source, any proprietary source, and may be related to exploration, production and pipelines from any state.

The system of FIG. 2 also includes permanent or removable storage, such as magnetic and optical discs, RAM, ROM, etc. on which the process and data structures of the embodiments can be stored an distributed. The processes can also be distributed via, for example, downloading over a network such as the Internet.

The many features and advantages of the embodiments are apparent from the detailed specification and, thus, it is intended by the appended claims to cover all such features and advantages of the embodiments that fall within the true spirit and scope of the embodiments. Further, since numerous modifications and changes will readily occur to those skilled in art, it is not desired to limit the embodiments to the exact construction and operation illustrated and described, and accordingly all suitable modifications and equivalents may be resorted to, falling within the scope of the embodiments.

What is claimed is:

1. A method for generating land map overlays identifying hydrocarbon production related data associated with a land area of interest, the method comprising the steps:
identifying real property related oil and gas data selected from the group consisting of: master land description, well information data, drilling data, pooling data, production data, leasing data, spacing data, not held by production data, and plugging data, wherein each data group is associated with real property;
the user selecting a land area of interest;
the user selecting at least one operation to build an output file to be related to the land area of interest from the group consisting of: drilling activity, drilling completions, open acreage, well information, vertical well production bars, land activity, vertical well production bars, land boundary, section information, non-held by production data, leasing activity and combinations thereof;
using a first computer system to build the output file associated with the selected operations;
using said first computer system or a second computer system to open said output file as an overlay associated with the land area of interest and displayed on a map over the land area of interest.

2. The method of claim 1, wherein said land area of interest is identify by longitude and latitude coordinates or by section number coordinates.

3. The method of claim 1, wherein said overlay is projected as a simulated three-dimensional view over the land map area of interest.

4. The method of claim 1, wherein when said overlay further identifies a corporate entity associated with the selected operation.

5. The method of claim 1, wherein following the step of selecting the land area of interest, further comprising the step of storing the identified land area of interest in a database associated with said computer system.

6. The method of claim 1, wherein at least a portion of the identified oil and gas data is obtained from public state records maintained by the government entity responsible for oil and gas exploration and production.

7. The method of claim 1, wherein the identified real property related oil and gas data is data filed with governmental agencies.

8. The method of claim 1, wherein the drilling data is data filed with governmental agencies, wherein the drilling data is selected from the group consisting of: drilling permits, spud reports, completions, recompletion applications and enhanced recovery filings

9. The method of claim 1, wherein the operation selected is drilling activity and further comprises the steps of:
opening an editable output file;
writing file headers into the file;
writing display format information to an output file including company name, permits, spuds, completions;
selecting drilling activity information recorded with governmental agencies for the land area of interest;
identifying drilling activity information recorded with governmental agencies within the area of interest and writing the coordinates and drilling activity information to the appropriate headers within the output file;
closing the output file; and,
viewing the output file.

10. The method of claim 9, wherein the output file distinguishes different drilling activity information from one another by use of geometrical shapes.

11. The method of claim 1, wherein the leasing data is data filed with governmental agencies, wherein the leasing data includes leasing company name and lease grantee.

12. The method of claim 1, wherein the operation selected is leasing activity and further comprises the steps of:
opening an editable output file;
writing file headers into the file;
writing display format information to an output file;
selecting leasing data records recorded with governmental agencies for the land area of interest;
identifying leases within the area of interest and writing the coordinates for the leased property to the output file;
closing the output file; and,
viewing the output file.

13. The method of claim 1, wherein the well information data is data filed with governmental agencies, wherein the well information data is selected from the group consisting of operator name, API number, gas production, oil production, well depth, formation, date production start, date production stopped and combinations thereof.

14. The method of claim 1, wherein the operation selected is well information and further comprises the steps of:
opening an editable output file;
writing file headers into the file;
writing display format information to an output file, said display information including operator name, API number, gas production, oil production, well depth, formation, date production start, date production stopped;
selecting well information recorded with governmental agencies for the land area of interest;
identifying well information within the area of interest, writing the coordinates and well information to the appropriate headers within the output file;
closing the output file; and,
viewing the output file.

15. The method of claim 1, wherein the operation selected is drilling completions and further comprises the steps of:
opening an editable output file;
writing file headers into the file;
writing display format information to an output file including company name, completions and initial production volumes and time information;
selecting drilling completion information recorded with governmental agencies for the land area of interest;
identifying drilling completion information recorded with governmental agencies within the area of interest and writing the coordinates and drilling activity information to the appropriate headers within the output file;
closing the output file; and,
viewing the output file.

16. The method of claim 15, wherein the output file is displayed as vertical bars and wherein the height of the vertical bars display relative production values.

17. The method of claim 1, wherein the real property related oil and gas data is pooling data and wherein the operation selected is land activity and further comprises the steps of:
opening an editable output file;
writing file headers into the file;
writing display format information to an output file including company name and time data;
selecting pooling data recorded with governmental agencies for the land area of interest;
identifying pooling data recorded with governmental agencies within the area of interest and writing the coordinates and pooling data to the appropriate headers within the output file;
closing the output file; and,
viewing the output file.

18. The method of claim 1, wherein the real property related oil and gas data is well output data for the most recent month production volume and wherein the operation selected is, vertical well production bars and further comprises the steps of:
opening an editable output file;
writing file headers into the file;
writing display format information to an output file including company name and time data;
selecting production data for the last month recorded with governmental agencies for the land area of interest;
identifying production data for the last month recorded with governmental agencies within the area of interest and writing the coordinates and production data to the appropriate headers within the output file;
closing the output file; and,
viewing the output file.

19. The method of claim 18, wherein the output file is viewed as vertical bars, wherein the vertical bars are comparable on a BTU value basis.
